(19) United States
(12) Patent Application Publication
(10) Pub. No.: US 2026/0113809 A1
(43) Pub. Date: Apr. 23, 2026

(54) BASE STATION AND DRX CONFIGURATION METHOD OF BASE STATION AND USER EQUIPMENT

(71) Applicant: ELECTRONICS AND TELECOMMUNICATIONS RESEARCH INSTITUTE, Daejeon (KR)

(72) Inventor: Nak Woon SUNG, Daejeon (KR)

(73) Assignee: ELECTRONICS AND TELECOMMUNICATIONS RESEARCH INSTITUTE, Daejeon (KR)

(21) Appl. No.: 19/360,716

(22) Filed: Oct. 16, 2025

(30) Foreign Application Priority Data
Oct. 21, 2024 (KR) 10-2024-0144050

(51) Int. Cl. H04W 76/28; H04W 48/18; H04W 52/02

(52) U.S. Cl. CPC H04W 76/28; H04W 48/18; H04W 52/0216

(57) ABSTRACT

Provided are a base station and discontinuous reception (DRX) configuration methods of a base station and user equipment (UE). The base station includes a first communication module configured to provide a 5^{th} Generation (5G) communication channel to user equipment (UE) in a specified area, a second communication module configured to communicate with an access and mobility management function (AMF), and a processor functionally connected to the first and second communication modules. When a network slice is selected by the UE connected through the first communication module, the processor acquires DRX configuration information corresponding to the selected network slice from the AMF through the second communication module and transmits a DRX timing in accordance with the DRX configuration information to the UE through the first communication module.

### CROSS-REFERENCE TO RELATED APPLICATION

This application claims priority to and the benefit of Korean Patent Application No. 10-2024-0144050, filed on Oct. 21, 2024, the disclosure of which is incorporated herein by reference in its entirety.

### BACKGROUND

### 1. Field of the Invention

Various exemplary embodiments disclosed in the present document relate to power-saving technology.

### 2. Discussion of Related Art

Along with an increase in the scale of mobile communication systems, network operators' energy costs are increasing significantly. For example, 5^{th} Generation (5G) networks have data transmission and reception rates about four times higher than existing 4^{th} Generation (4G) networks in terms of energy efficiency. However, 5G networks run a larger number of cells and deploy more antennas to provide the same coverage, resulting in energy consumption that increases by about three times.

To address this, 5G New Radio (NR) provides energy-saving technologies such as beamforming using massive multiple-input and multiple-output (MIMO), spatial multiplexing gain, and the like. Also, 5G NR does not depend on always-on reference signals due to the lean carrier design, enabling energy savings by supporting an efficient base station sleep mode with a longer sleep period and a higher sleep ratio. Further, 5G NR may reduce energy consumption by utilizing user equipment (UE) energy-saving technologies for minimizing transmission/reception operations of UE such as a discontinuous reception (DRX) mode.

Meanwhile, mobile communication networks are configured as separate physical networks in accordance with their service purposes. Therefore, with users'requests being diversified, service providers incur significant costs in configuring, maintaining, and managing individual physical networks in accordance with services.

### SUMMARY OF THE INVENTION

To solve this problem, 5^{th} Generation (5G) New Radio (NR) has introduced network slice technology for slicing a single physical network into logical virtual networks and using each virtual network as an independent network in accordance with a service purpose.

Since the network slice technology may reduce the total number of physical networks, energy consumed for operating and maintaining physical networks may be theoretically reduced. However, the same method is applied to current energy-saving operations of user equipment (UE) connected to network slices irrespective of the connected network slices.

Various embodiments disclosed in the present document may provide a discontinuous reception (DRX) configuration method of a base station and UE for setting DRX in accordance with a network slice used by the UE.

According to an embodiment disclosed in the present document, there is provided a base station including a first communication module configured to provide a 5G communication channel to UE in a specified area, a second communication module configured to communicate with an access and mobility management function (AMF), and a processor functionally connected to the first and second communication modules. When a network slice is selected by the UE connected through the first communication module, the processor acquires DRX configuration information corresponding to the selected network slice from the AMF through the second communication module and transmits a DRX timing in accordance with the DRX configuration information to the UE through the first communication module.

According to an embodiment disclosed in the present document, there is provided a DRX configuration method of a base station, the method including receiving requested network slice selection assistance information (NSSAI) from UE and transmitting default DRX configuration information to the UE during a radio resource control (RRC) setting procedure of the UE, checking a default AMF or a target AMF related to the requested NSSAI in accordance with a temporary identifier of the UE, acquiring an allowed NSSAI value and DRX configuration information corresponding to the allowed NSSAI value through the checked target AMF or a target AMF additionally determined through the default AMF, and transmitting an RRC reconfiguration message including the acquired DRX configuration information to the UE.

According to another embodiment disclosed in the present document, there is provided a DRX configuration method of UE, the method including transmitting requested NSSAI to a base station during an RRC setting procedure, when default DRX configuration information is received from the base station, setting a default DRX timing corresponding to the default DRX configuration information, acquiring an allowed NSSAI value and DRX configuration information corresponding to the allowed NSSAI value from a target AMF supporting the requested NSSAI through the base station, and resetting a DRX configuration to a DRX timing corresponding to the allowed NSSAI value on the basis of the acquired DRX configuration information.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing a mobile communication system;

FIG. 2 is a diagram illustrating an operation mode of user equipment (UE) according to an embodiment;

FIG. 3 is a sequence diagram illustrating a procedure for receiving discontinuous reception (DRX) configuration information according to an embodiment;

FIG. 4 is a diagram showing three major technical requirement domains of 5^{th} Generation (5G) radio access technology according to an embodiment;

FIG. 5 is a diagram showing a structure of a 5G mobile communication network slice according to an embodiment;

FIG. 6 is a diagram showing a DRX configuration procedure based on a network slice according to an embodiment;

FIG. 7 is a block diagram of a base station according to an embodiment;

FIG. 8 is a block diagram of UE according to an embodiment;

FIG. 9 is a flowchart of a DRX configuration method of a base station according to an embodiment; and

FIG. 10 is a flowchart of a DRX configuration method of UE according to an embodiment.

In relation to the description of drawings, like reference numerals may be used for like components.

### DETAILED DESCRIPTION OF EXEMPLARY EMBODIMENTS

As used herein, a term for indicating an access node, a term for indicating network entities, a term for indicating messages, a term for indicating an interface between network objects, a term for indicating various kinds of identification information, and the like are exemplified for convenience of description. Accordingly, the present disclosure is not limited to the terms described below, and other terms indicating objects having equivalent technical meanings may be used.

In the following description, the terms “physical channel” and “signal” may be interchangeably used with “data” and “control signal,” respectively. For example, the term “physical downlink shared channel (PDSCH)” indicates a physical channel through which data is transmitted, but the term may also be used for indicating data. In other words, in the present disclosure, the phrase “transmitting a physical channel” may be construed the same as “transmitting data or a signal via a physical channel.”

In the present disclosure, higher-layer signaling is a signal transmission scheme in which a signal is transferred from a base station to user equipment (UE) using a downlink (DL) data channel at a physical layer or a signal is transferred from UE to a base station using an uplink (UL) data channel at a physical layer. Higher-layer signaling may be understood as radio resource control (RRC) signaling or a media access control (MAC) control element (CE).

For convenience of description, in the present disclosure, terms and names defined in the 3^{rd} Generation Partnership Project (3GPP) New Radio (NR) or 3GPP Long Term Evolution (LTE) standard. However, the present disclosure is not limited to the terms and names and may be applied to systems conforming to other standards. In the present disclosure, the term “next generation Node B (gNB)” may be interchangeably used with the term “evolved node B (eNB)” for convenience of description. In other words, a base station described as an eNB may indicate a gNB. Also, the term “UE” may indicate not only a cellular phone, a machine-type communication (MTC) device, a narrowband (NB)-Internet of things (IoT) device, and a sensor but also other wireless communication devices.

In particular, the present disclosure may be applied to 3GPP NR (the 5^{th} generation mobile communication standard). Also, the present disclosure may be applied to intelligent service (e.g., a smart home service, a smart building service, a smart city service, a smart car or connected car service, a healthcare service, a digital education service, a retail service, a security and safety-related service, etc.) on the basis of 5^{th} Generation (5G) communication technology and IoT-related technology. In the present disclosure, the term “gNB” may be interchangeably used with the term “eNB” for convenience of description. In other words, a base station described as an eNB may indicate a gNB. Also, the term “UE” may indicate not only cellular phones, NB-IoT devices, and sensors but also other wireless communication devices.

Wireless communication systems are evolving from their initial focus on voice-centric services into broadband wireless communication systems that provide high-speed, high-quality packet data services on the basis of communication standards such as high speed packet access (HSPA) of 3GPP, LTE or evolved universal terrestrial radio access (E-UTRA), LTE-advanced (LTE-A), LTE-Pro, high rate packet data (HRPD) of 3GPP2, ultra mobile broadband (UMB), Institute of Electrical and Electronics Engineers (IEEE) 802.16e, and the like.

As an example of a broadband wireless communication system, an LTE system employs an orthogonal frequency division multiplexing (OFDM) scheme in a DL and employs single carrier frequency division multiple access (SC-FDMA) scheme in an UL. A UL is a wireless link through which UE or a mobile station (MS) transmits data or a control signal to a base station (or an eNode B). Also, A DL is a wireless link through which a base station transmits data or a control signal to UE. According to the foregoing multiple access scheme, time-frequency resources for carrying data or control information for each user are allocated and managed not to overlap, that is, to be orthogonal to, those for other users such that data or control information of each user is distinguished.

As a communication system succeeding LTE, a 5G communication system is to accommodate diverse requirements from users, service providers, etc., and therefore it is necessary to support a service that simultaneously satisfy a variety of requirements. Services considered for 5G communication systems are enhanced mobile broadband (eMBB), massive MTC (mMTC), ultra reliability low latency communication (URLLC), and the like.

According to some embodiments, eMBB may aim to provide a data transmission rate that is significantly higher than that supported by existing LTE, LTE-A, or LTE-Pro. For example, in a 5G communication system, eMBB need to provide a peak data rate of 20 Gbps for a DL and 10 Gbps for a UL from a single base station perspective. Also, a 5G communication system is to provide a peak data rate while providing increased user-perceived data rates for UE. To meet such requirements, 5G communication systems may necessitate improvements in various transmission and reception technologies, including enhanced multiple-input and multiple-output (MIMO) transmission technology. Also, while current LTE systems transmit signals using a maximum transmission bandwidth of 20 MHz in a 2 GHz band, 5G communication systems may satisfy required data transmission rates by utilizing a frequency bandwidth wider than 20 MHz in a frequency band of 3 to 6 GHz or 6 GHz or higher.

At the same time, mMTC is being considered to support application services, such as the IoT, in 5G communication systems. mMTC may require support for massive UE connections within cells, improved UE coverage, enhanced battery life, reduced UE costs, etc., to efficiently provide the IoT. The IoT is attached to various sensors and devices and provides a communication function thereto and thus a large number of pieces of UE within a cell (e.g., 1,000,000 pieces of UE/km²) is required. Also, UE supporting mMTC is likely to be located in shadow areas where cells do not provide coverage, such as underground areas within buildings, due to the nature of the service. Accordingly, those pieces of UE may require broader coverage compared to other services provided by 5G communication systems. Since UE supporting mMTC is a low-cost device and it is difficult to frequently replace its battery, an extremely long battery lifetime of 10 to 15 years may be required.

Lastly, URLLC is a cellular-based wireless communication service used for specific mission-critical purposes such as remote control of robots or machinery, industrial automation, unmanned aerial vehicles, remote healthcare, emergency alerts, and the like. Therefore, URLLC is to provide very low latency (ultra low latency) and very high reliability (ultra high reliability). For example, services supporting URLLC may be to satisfy an air interface latency of less than 0.5 milliseconds and may require a packet error rate of 10⁻⁵. Therefore, for services supporting URLLC, 5G systems are to provide a smaller transmit time interval (TTI) than other services. 5G systems may be designed to allocate a wide range of resources in a frequency band in order to ensure reliability of a communication link.

The foregoing three services considered in 5G communication systems, that is, eMBB, URLLC, and mMTC, may be multiplexed and transmitted by one system. Here, to meet different requirements of the services, different transmission and reception techniques and transmission and reception parameters may be used. However, the foregoing mMTC, URLLC, and eMBB are merely examples of different kinds of services, and the types of services to which the present disclosure is applied are not limited thereto.

Embodiments of the present disclosure are described below using LTE, LTE-A, LTE Pro, or 5G (or NR, next-generation mobile communication) systems as examples, but embodiments of the present disclosure may also be applied to other communication systems having a similar technical background or channel configuration. In addition, embodiments of the present disclosure may be partially modified without significantly departing from the scope of the present disclosure as determined by those or ordinary skill in the art, and applied to other communication systems.

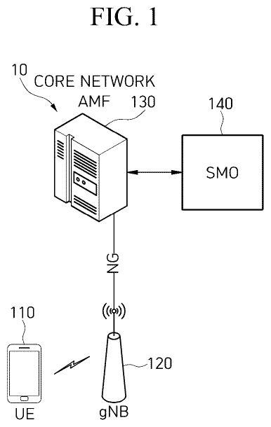

FIG. 1 is a diagram showing a mobile communication system.

Referring to FIG. 1, a mobile communication system 10 may include service management & orchestration (SMO) 140, a core network (CN) 130, a base station 120, and UE 110. The mobile communication system 10 may support 4^{th} Generation (4G) communication (e.g., LTE and LTE-A) defined in the 3GPP standard, 5G communication (e.g., NR), and the like. 4G communication may be performed within a frequency band of 6 GHz or less, and 5G communication may be performed within not only a frequency band lower than 6 GHz or but also a frequency band of 6 GHz or higher. For example, for 4G communication and 5G communication, a plurality of UE may support a code division multiple access (CDMA)-based communication protocol, a wideband CDMA (WCDMA)-based communication protocol, a time-division multiple access (TDMA)-based communication protocol, a frequency-division multiple access (FDMA)-based communication protocol, an orthogonal frequency division multiplexing (OFDM)-based communication protocol, a filtered OFDM-based communication protocol, a cyclic prefix (CP)-OFDM-based communication protocol,, orthogonal frequency division multiple access (OFDMA)-based communication protocol, a single carrier (SC)-FDMA-based communication protocol, a non-orthogonal multiple access (NOMA)-based communication protocol, a generalized frequency division multiplexing (GFDM)-based communication protocol, a filter bank multi-carrier (FBMC)-based communication protocol, a universal filtered multi-carrier (UFMC)-based communication protocol, a space division multiple access (SDMA)-based communication protocol, and the like.

The SMO 140 is a system that manages and controls a network and may support network slicing, resource management, or operation related to service quality.

When the mobile communication system 100 supports 5G communication, the CN 130 may include a user plane function (UPF), a session management function (SMF), and an access and mobility management function (AMF). The CN 130 may perform data processing, session management, mobility management, and security management of the UE 110. The CN 130 may process data received from the base station 120 and transmit the processed data to the SMO 140 via an external network (e.g., the Internet).

The base station 120 is a part of a radio access network (RAN) and may provide a wireless connection between the UE 110 and the CN 130 and allocate resources to the UE 110. The base station 120 may transmit data (UL data) received from the UE 110 to the CN 130 and transmit data received from the CN 130 to the UE 110. Although the base station 120 may be at least one of a gNodeB (gNB), an eNode B (eNB), a NodeB, a base station (BS), a radio access unit, a base station controller, and a node in the network, a case where the base station 120 is a gNB (5G base station) will be described as an example in the present document.

The UE 110 may include user equipment (UE), a mobile station (MS), a cellular phone, a smartphone, a computer, or a multimedia system that may perform a communication function. The UE 110 is obviously not limited thereto.

The UE 110 may support a discontinuous reception (DRX) function for reducing power consumption. Specifically, the UE 110 may reduce power consumption by turning off (deactivate) a receiver (e.g., a radio frequency (RF) transceiver) when data is not transmitted, and turning on the receiver only when it is necessary to transmit or receive data. For example, when there is no traffic, the UE 110 may enter a sleep mode for a certain period and periodically wake up to check whether there is traffic. When there is traffic, the UE 110 enters an active mode to transmit or receive data. The sleep mode may be a mode in which the RF transceiver of the UE 110 is turned off, and the active mode may be a mode in which the RF transceiver is turned on.

The base station 120 transmits configuration information (DRX-config) related to a time point at which the UE 110 enters the sleep mode, a period in which the UE 110 is in the sleep mode, and a time when the UE 110 wakes up to the UE 110 using a higher-layer control message or a system information block type 2 (SIB2) message broadcast by the base station.

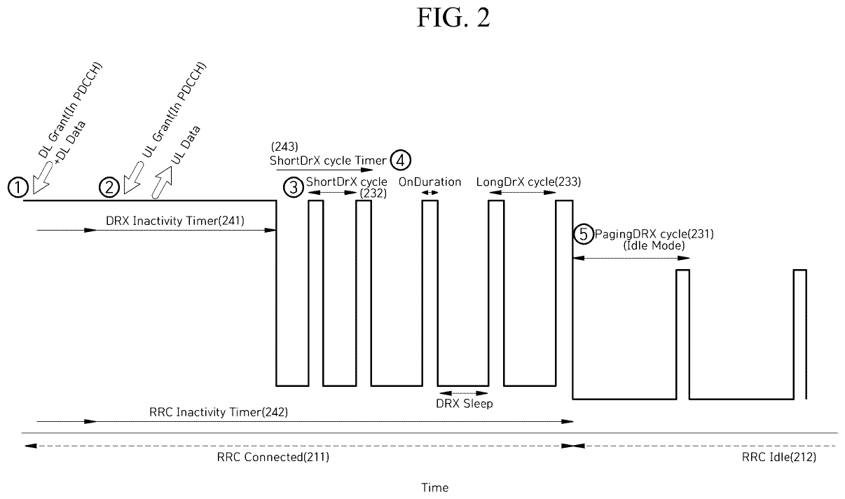

FIG. 2 is a diagram illustrating an operation mode of UE according to an embodiment. FIG. 2 illustrates a timing diagram of a case where UE switches from an RRC connected state 211 to an RRC idle state 212. In the timing diagram of FIG. 2, the time elapses from the left to the right. Therefore, after the RRC idle state 212, the UE may be switched to another RRC connected state, and in this case, timings may be similar to the RRC connected state 211.

The LTE and NR standards support idle mode DRX and connected mode DRX (hereinafter, also referred to as “C-DRX”).

Referring to FIG. 2, idle mode DRX is DRX applied to the RRC idle state 212, and C-DRX is DRX applied to the RRC connected state 211.

When only idle mode DRX is supported, the UE 110 in the RRC connected state 211 (i.e., not in an idle state) monitors a physical downlink control channel (PDCCH) in every subframe or slot irrespective of whether data is received. On the other hand, when C-DRX is supported, the UE 110 may turn off the RF transceiver to reduce power (e.g., battery) consumption even in an RRC connected state if there is no actual transmission or reception traffic. Therefore, in the sleep mode, power consumption of the UE 110 is reduced by the amount of time that the UE 110 spends in an RRC inactive state.

In LTE or NR communication, the base station 120 pages the UE 110 in the RRC idle state 212 when there is DL traffic. In the idle mode DRX, the UE 110 wakes up at intervals of a paging DRX cycle 231 to check whether there is paging and monitors the PDCCH. When there is paging, the UE 110 switches to an RRC connected state to receive traffic, and when there is no traffic thereafter for a certain time period, enters the sleep mode again.

To manage the idle mode DRX, the UE 110 acquires configuration information, such as the paging DRX cycle 231, from a higher-layer control message or an SIB2 message broadcast by the base station 120 and monitors the PDCCH only in wireless frames/subframes or slots specified in accordance with the configuration information.

Referring to FIG. 2, when there is traffic during the paging DRX cycle 231, the UE switches to the RRC connected state 211. In the RRC connected state 211, the UE 110 monitors scheduling information (a DL grant). When DL data is received, the UE 110 restarts a DRX inactivity timer 241 and an RRC inactivity timer 242. Subsequently, when the DRX inactivity timer 241 expires, a DRX mode begins. In the DRX mode, the UE wakes up at intervals of a DRX cycle (a short DRX cycle 232 or a long DRX cycle 233) to periodically monitor the PDCCH for a determined time (OnDuration). In LTE, two kinds of DRX cycles (short DRX cycle and long DRX cycle) are defined, and the short DRX cycle 232 is optional.

If short DRX is set, when the UE 110 switches to the DRX mode, the UE 110 operates with the short DRX cycle 232 and turns to the long DRX cycle 233. Since the long DRX cycle 233 is set to a multiple of the short DRX cycle 232, the UE 110 wakes up more frequently at the short DRX cycles 232 than at the long DRX cycles 232. When the RRC inactivity timer 242 expires, the UE 110 switches to an idle state and operates with the paging DRX cycle 231 again.

Referring to FIG. 2, an example of an idle mode DRX and connected mode DRX operation of the UE 110 is as follows.

As shown in operation \textcircled{1} in an RRC connected mode, the UE 110 continuously monitors the PDCCH in every subframe or slot. When there is a DL grant and DL data, the UE 110 restarts the DRX inactivity timer 241 and the RRC inactivity timer 242.

As shown in operation \textcircled{2} in the RRC connected mode, the UE 110 may request data transmission from the base station 120 to receive an UL grant and may transmit transmission data (UL data) in accordance with the UL grant. When the UL grant is received, the UE 110 restarts the DRX inactivity timer 241 and the RRC inactivity timer.

As shown in operation \textcircled{3}, when no UL or DL grant is received by the UE 110 for a certain period, the DRX inactivity timer 241 and the RRC inactivity timer 242 expire. In this case, the short DRX cycle 232 begins, and thus the UE 110 may reduce power consumption by starting the short DRX cycle timer 243 and turning off the RF transceiver.

As shown in operation \textcircled{4}, when the short DRX cycle timer 243 expires, the UE 110 terminates the short DRX cycle 232 and operates with the long DRX cycle 233.

As shown in operation \textcircled{5}, when there is no action on the UL or DL during the long DRX cycle 233, the RRC inactivity timer 242 expires. When the RRC inactivity timer 242 expires, the UE 110 switches to the RRC idle state 212 to operate with the paging DRX cycle 231.

As shown in the timing diagram after operation \textcircled{5}, the UE 110 in the RRC idle state 212 monitors the PDCCH in one subframe or slot (OnDuration) during each paging DRX cycle 231.

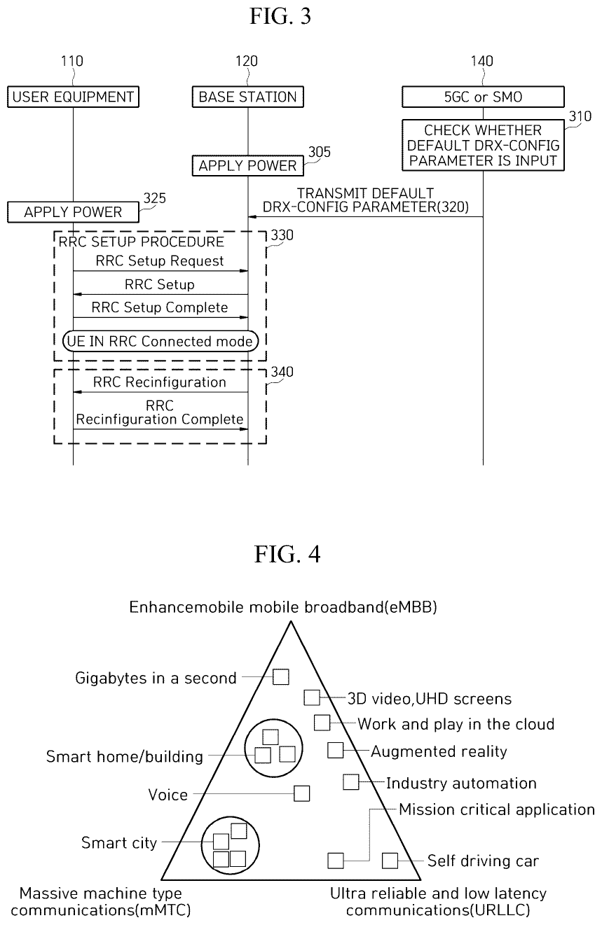

FIG. 3 is a sequence diagram illustrating a procedure for receiving DRX configuration information according to an embodiment. FIG. 3 illustrates a procedure for receiving DRX configuration information (DRX-config) between the UE 110 and the base station 120.

In operation 310, when it is confirmed that a default DRX-config parameter for the base station 120 is input, the SMO (or 5G CN (5GC)) 140 transmits the input default DRX-config parameter to the base station 120. In this regard, an administrator may input the default DRX-config parameter for the base station 120 when the base station 120 is initially started in the 5GC or an open radio access network (ORAN).

When the base station 120 is powered on and initially started (305), the base station 120 may receive the default DRX-config parameter from the SMO 140 in operation 320.

After the UE 110 is powered on and initially started (325), the UE 110 may receive default DRX configuration information from the base station 120 during an RRC setup process 330 or a subsequent RRC reconfiguration process 340. The DRX configuration information may be transmitted via an RRC setup message or an RRC reconfiguration message. The DRX configuration information may be transmitted as the DRX-config parameter in a masterCellGroup, CellGroupConfig, or media access control (MAC)-CellGroupConfig information element (IE) in the messages. The DRX configuration information includes parameters such as drx-onDuration, drx-InactivityTimer, drx-ShortCycle, drx-ShortCycleTimer, drx-HARQ-RTT-TimerDL, drx-HARQ-RTT-TimerUL, drx-RetransmissionTimerDL, drx-RetransmissionTimerUL, and drx_SlotOffset. The parameter drx-onDuration may be intended to set a period during which the UE 110 remains awake within a DRX cycle. The parameter drx-InactivityTimer may be a period during which the UE remains awake after receiving DRX configuration information. The parameter drx-ShortCycle may be a short DRX cycle. The parameter drx-ShortCycleTimer may be a period during which short DRX cycles are used. The parameters drx-HARQ-RTT-TimerDL and drx-HARQ-RTT-TimerUL may be hybrid automatic repeat request (HARQ) retransmission waiting times during which the base station 120 remains awake to detect a transmission error and request retransmission for the DL or UL, respectively. The parameters drx-Retransmission-TimerDL and drx-Retransmission-TimerUL may be retransmission waiting times during which the UE 110 remains awake while waiting for retransmission for the DL or UL, respectively. The parameter drx-SlotOffset may be a time difference between a DRX cycle and an HARQ retransmission timing.

Referring back to FIG. 1, the UE 110 may negotiate with the AMF (the CN 130) to set a DRX configuration parameter separately from the aforementioned procedures. The UE 110 may transmit a desired DRX-config parameter to the AMF (the CN 130) using a requested DRX parameter IE message during an initial registration procedure or a mobility registration procedure. The AMF (the CN 130) may allow at least some of DRX-config parameters requested in accordance with network operation policies.

Therefore, the UE 110 may perform a DRX operation using DRX-config parameters negotiated with the AMF (the CN 130) or DRX-config parameters broadcast by the base station 120.

Since a DRX cycle is synchronized between the UE 110 and the base station 120, the base station schedules traffic for the UE 110 in accordance with whether the UE 110 is currently in a DRX sleep state or an on-duration state on the basis of a DRX cycle. For example, when there is DL traffic to the UE 110, the base station 120 waits during a DRX sleep period of the UE 110 and transmits the traffic at the earliest wake-up time. Therefore, transmission of the traffic is delayed by a remaining DRX sleep period.

On the other hand, during UL transmission, the UE 110 may make a service request (SR) for UL traffic whenever necessary, and thus is not affected by a DRX operation. Even in a DRX mode, the UE 110 transmits an SR to the base station 120 to request an UL grant when there is UL traffic. The UE 110 may manage the DRX mode on the basis of the DRX configuration information forwarded from the base station 120, and the base station 120 may control a DRX operation of the UE 110 by transmitting MAC CE DRX commands.

FIG. 4 is a diagram showing three major technical requirement domains of 5G radio access technology according to an embodiment.

5G technology is establishing itself as a core technology for future industries, driven by the proliferation of contactless services and increasing demand for high-speed and high-quality services. In 2015, the international telecommunication union (ITU) defined three service scenarios for 5G and derived performance requirements for 5G systems. The defined three service scenarios include eMBB, URLLC, and mMTC.

3GPP defines a new RAN called NR and a new CN called 5GC to satisfy three major service scenario requirements proposed by the ITU. NR is a 5G standard designed for a single system to support three services with requirements of different characteristics.

In addition, 5GCs are designed to support access from wireless networks such as LTE, NR, and Wi-Fi, within a single frame while aiming at a network architecture for accommodating various RANs. Like this, 5G technology can provide diversified and varied communication services flexibly, at scale, and in a reliable manner.

Meanwhile, networks according to the related art are configured as separate physical networks in accordance with service purposes. Accordingly, service providers incur significant costs for physical network configuration and network maintenance management associated with each service.

To address this issue, 3GPP introduces network slice technology for slicing a single physical network into logical virtual networks and using each virtual network as an independent network in accordance with a service purpose, 5G networks may define and utilize optimized virtual network resources and paths through network slicing in accordance with specific applications and services.

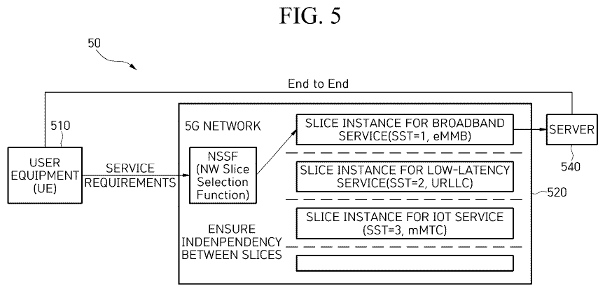

FIG. 5 is a diagram showing a structure of a 5G mobile communication network slice according to an embodiment.

Each network slice includes end-to-end (E2E) network resources spanning an entire network path such as an individual user entity (UE) 510 (the UE 110 of FIG. 1), a RAN, a CN, and the like. Network slices may provide dedicated networks specialized for an ultra-high speed 5G service, an ultra-low latency 5G service, and an ultra-connectivity 5G service with different characteristics and quality of service (QoS) requirements within a single physical network. To this end, functional attributes, such as network isolation, customization, independent management, orchestration, etc., may be applied to the CN and the RAN.

In 3GPP, the UE 510 may be connected to one or more network slice instances via a single 5G access connection in accordance with a service being used. The current standard allows simultaneous connections to up to eight network slices. However, even when connected to multiple network slices, the UE 510 is connected to one AMF instance for connection and mobility management, and the AMF instance is shared with the simultaneously connected slice instances. When the UE 510 transmits service requirement information to a 5G network, the CN 130 is to select an appropriate network instance using the service requirement information on the basis of a network slice selection function (NSSF).

Meanwhile, functions and attributes of network slices are defined as network slice selection assistance information (NSSAI) values on the basis of QoS. For example, a 32-bit NSSAI includes an 8-bit slice/service type (SST) and a 24-bit slice differentiator (SD). The SST represents a service type and a slice type, and the SD is an identifier for identifying the same SST network. In current 3GPP, based on service characteristics, an eMBB SST, a URLLC SST, an mMTC SST, a vehicle to everything (V2X) SST, and a high-performance machine-type communication (HMTC) SST are defined as 1, 2, 3, 4, and 5, respectively.

A single network slice may be configured as an E2E logical network extending from the UE 510 to destination UE or a server 540 (e.g., the SMO 140 of FIG. 1) via the CN 130.

In 3GPP, the UE 510 may access one of network slices in accordance with a characteristic of an application being used and receive a service. For example, when the application used by the UE 510 is an eMBB service, the UE 510 accesses the server 540 via a network slice instance with an SST of 1.

According to the above-described embodiment, the UE 510 may perform a DRX operation on the basis of DRX configuration information received from a base station 530 during a setup process. The UE 510 may perform the DRX operation without considering QoS characteristics of the application being used or a type of network slice instance. For example, the UE 510 may be set to perform the same DRX operation (e.g., drx-onDuration) without considering whether the accessed network slice instance is for eMBB, URLLC, or mMTC. In this case, however, there are limitations to improving the power consumption efficiency of the UE 510 through the DRX operation.

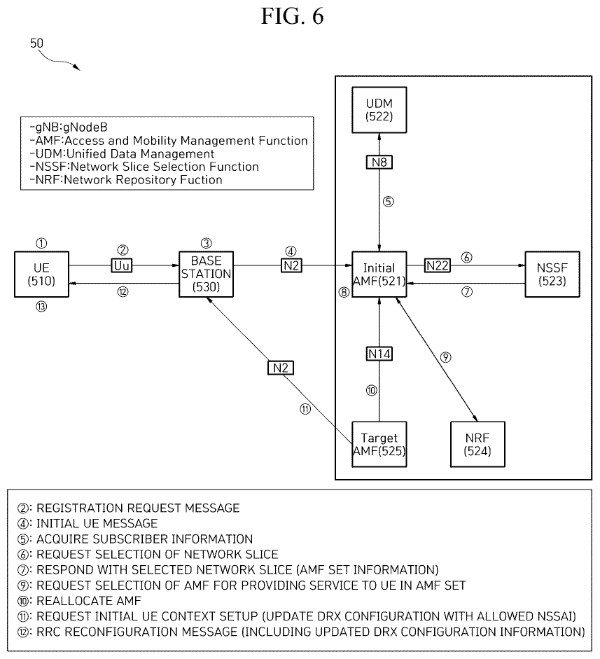

FIG. 6 is a diagram showing a DRX configuration procedure based on a network slice according to an embodiment.

Referring to FIG. 6, in operation \textcircled{1}, the UE 510 may generate a requested NSSAI value in accordance with specified UE configuration information or configuration policies. The NSSAI value may be a 32-bit value that defines a function and attribute of a network slice on the basis of QoS. The NSSAI value may be composed of an 8-bit SST and a 24-bit SD. The SST indicates a service type and a slice type, and the SD is an identifier for identifying the same SST network. In the 3GPP standard, based on service characteristics, an eMBB SST, a URLLC SST, an mMTC SST, a V2X SST, and a HMTC SST are defined as 1, 2, 3, 4, and 5, respectively. Network slices with the same SST may be identified on the basis of their SD value. The UE configuration information and configuration policies may be received from the SMO in advance.

In operation \textcircled{2}, the UE 510 performs a network initial access procedure (registration procedure). For example, the UE 510 generates a registration request message including the requested NSSAI value. The requested NSSAI value may be included in a requested NSSAI IE of the registration request message.

The UE 510 may transmit the registration request message to the base station 530 through an RRC setup procedure (330 of FIG. 3) and receive default DRX configuration information via an RRC setup message from the base station 530. In this case, the UE 510 may perform a DRX operation in accordance with the default configuration information.

In operation \textcircled{3}, the base station 530 selects a target AMF that may support a network slice in accordance with the requested NSSAI value from the UE 510. For example, the base station 510 may check a target AMF 525 that may support a network slice selected by the UE 510 using a 5G temporary mobile subscriber identity (TMSI) and a single NSSAI (S-NSSAI) value of the UE 510. When the base station 530 is not aware of information on the target AMF 525, the base station accesses a default AMF.

In operation \textcircled{4}, the base station 530 transmits an initial UE message including the registration request received from the UE 510 to an initial AMF (default AMF) 521. The initial UE message may include a requested NSSAI parameter.

In operation \textcircled{5}, the initial AMF 521 accesses unified data management (UDM) 522 included in the CN 130 and requests subscriber information related to the UE 510 that has transmitted the registration request message. The initial AMF 521 may check network slice information (subscribed NSSAI) that is available to the UE 510 from the subscriber information. The subscriber information may include at least one of subscription information, authentication information, and policy information related to a subscriber. The subscription information may include NSSAI to which the subscriber (a user of the UE 510) is subscribed (or enrolled).

In operation \textcircled{6}, the initial AMF 521 may transmit an Nnssf_NSSelection_Get (Query) message to an NSSF 523 to select the network slice selected by the UE 510. The Nnssf_NSSelection_Get message may include the requested NSSAI, subscribed NSSAI, a home public land mobile network (PLMN), and a tracking area identity (TAI). The home PLMN may be a network that is owned and run by a mobile communication service provider. The TAI may be information indicating an area where the UE 510 is located.

In operation \textcircled{7}, the NSSF 523 selects a network slice on the basis of requested network slice information and the subscriber information of the UE 510. The NSSF 523 transmits a message including the selected network slice information and AMF set information supporting the selected network slice to the initial AMF 521 using an Nnssf_NSSelection_Get_Response (Query result) message. The Nnssf_NSSelection_Get_Reponse (Query result) message may include an allowed NSSAI, a target AMF set, and an application programming interface (API) resource identifier (uniform resource identifier (URI)) parameter for accessing a network repository function (NRF) (a network function (NF) discovery service).

In operation \textcircled{8}, the initial AMF 521 check whether the initial AMF 521 itself is included in the target AMF set. When the initial AMF 521 is not included in the target AMF set, the initial AMF 521 generates an Nnrf_NFDiscovery_Request message for requesting information on the target AMF 525 from the NRF. The Nnrf_NFDiscovery_Request message may include a “target AMF set parameter.”

In operation \textcircled{9}, when the Nnrf_NFDiscovery_Request message is received from the initial AMF 521, an NRF 524 may select the single target AMF 525 that may provide a service to the UE 510 in the target AMF set and transmit information regarding the selected target AMF 525 to the initial AMF 521. The NRF 524 may transmit the Nnrf_NFDiscovery_Response message including an AMF set identifier and the API URI parameter to the initial AMF.

In operation \textcircled{10}, the initial AMF 521 performs an AMF reallocation process in communication with the target AMF 525. For example, the initial AMF 521 may transmit a Namf_Communication_N1MessageNotify message including the initial UE message received from the base station 530 and the allowed NSSAI value received from the NSSF 523 to the target AMF 525.

In operation □, the target AMF 525 may process the registration request from the UE 510 and transmit a registration accept message to the UE 510 in response thereto. The registration accept message may include allowed network slice information (the allowed NSSAI value) in the network in response to the requested network slice (the requested NSSAI) of the UE 510.

The target AMF 525 transmits an initial UE context setup message (an initial UE context setup request) to the base station 530 such that the base station 530 may request the UE 510 to set UE context information. For example, the target AMF 525 additionally transmit DRX configuration information corresponding to the allowed NSSAI value to the base station 530. The initial UE context setup message may include the registration accept message including allowed NSSAI and the DRX configuration information corresponding to the allowed NSSAI. In this way, in a mobile communication system 50 according to the embodiment, each of the AMFs 521 and 525 can manage DRX configuration information corresponding to each network slice.

In operation □, the base station 530 may receive the initial UE context setup message and generate UE context information of the UE 510. Also, the base station 530 updates DRX configuration information of the UE 510 from the “default DRX configuration information” set in operation \textcircled{2} to the “DRX configuration information corresponding to the allowed NSSAI.” The base station 530 may transmit an RRC reconfiguration message including the registration accept message (including the allowed NSSAI) and the updated DRX configuration information to the UE 510.

In operation □, the UE 510 may receive an RRC reconfiguration message including the DRX configuration information corresponding to the allowed NSSAI from the base station 530. The UE 510 updates a DRX configuration with the DRX configuration information corresponding to the allowed NSSAI and performs a DRX procedure in accordance with the updated DRX configuration.

As described above, the AMF 525 of the mobile communication system 50 according to an embodiment may provide appropriate DRX configuration information for a network slice selected during a registration procedure of the UE 510 to the base station 530 instead of default DRX configuration information which is set by the base station 530 upon initial access, and the base station 530 may provide updated DRX configuration information to the UE 510. Accordingly, the UE 510 can perform a DRX operation at timings in accordance with a network slice being used.

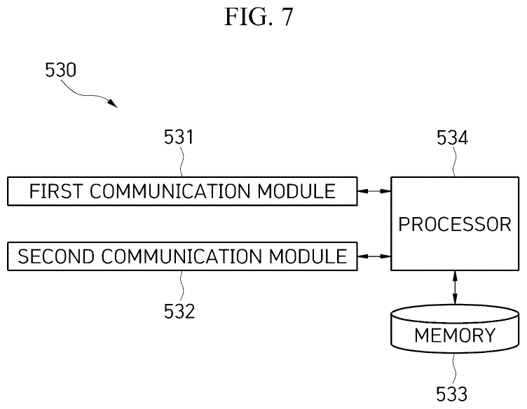

FIG. 7 is a block diagram of a base station according to an embodiment.

Referring to FIG. 7, the base station 530 according to the embodiment may include a first communication module 531, a second communication module 532, a memory 533, and a processor 534. According to the embodiment, some components of the base station 530 may be omitted, or additional components may be further included. In addition, some components of the base station 530 may be combined into one entity, and the entity may perform the same functions as the corresponding components before the combination.

The first communication module 531 may support establishing a communication channel or a wireless communication channel between the base station 530 and another device (e.g., the UE 510) and performing communication via the established communication channel. The communication channel may be a CDMA, global system for mobile communication (GSM), W-CDMA, time-division synchronous CDMA (TD-SCDMA), wireless broadband Internet (WiBro), LTE, or evolved packet core (EPC) communication channel.

The second communication module 532 may support establishing a communication channel or a wireless communication channel between the base station 530 and another device (e.g., each of the AMFs 521 and 525) and performing communication via the established communication channel. The communication channel may include at least one communication channel among LAN, fiber to the home (FTTH), digital subscriber line (xDSL), WiBro, wireless LAN, 3G, 4G, and 5G communication channels.

The memory 533 may include various kinds of volatile memories or non-volatile memories. For example, the memory 533 may include a read-only memory (ROM) and a random access memory (RAM). According to the embodiment, the memory 533 may be located inside or outside the processor 534, and the memory 533 may be connected to the processor 534 using various known means. The memory 533 may store various data used by at least one component (e.g., the processor 534) of the base station 530. The data may include, for example, software and input data or output data for a command related to the software. For example, the memory 533 may store at least one instruction and data for providing a DRX configuration service corresponding to a network slice.

The processor 534 may control at least one other component (e.g., a hardware or software component) of the base station 530 and perform various kinds of data processing or computation. The processor 534 may include at least one of, for example, a central processing unit (CPU), a graphics processing unit (GPU), a microprocessor, an application processor, an application-specific integrated circuit (ASIC), and a field programmable gate array (FPGA), and may have a plurality of cores.

According to the embodiment, the processor 534 may receive requested NSSAI from the UE 510 through the first communication module 531 during an RRC setup procedure. The processor 534 may transmit default DRX configuration information to the UE 510 through the first communication module 531.

The processor 534 may check a default AMF or a target AMF related to the requested NSSAI in accordance with a temporary identifier of the UE 510 from the memory 533.

When no target AMF is checked, the processor 534 may communicate with the default AMF (the initial AMF 521) through the second communication module 532 to additionally determine the target AMF 525.

The processor 534 may acquire an allowed NSSAI value corresponding to the requested NSSAI and DRX configuration information corresponding to the requested NSSAI from the checked or additionally determined target AMF 525 through the second communication module 532.

Each piece of the DRX configuration information may include parameters such as drx-onDuration, drx-InactivityTimer, drx-ShortCycle, drx-ShortCycleTimer, drx-HARQ-RTT-TimerDL, drx-HARQ-RTT-TimerUL, drx-RetransmissionTimerDL, drx-RetransmissionTimerUL, and drx-SLotOffset.

A network slice in accordance with the allowed NSSAI may include an SST value for identifying eMBB, URLLC, mMTC, V2X, or HMTC. The processor 534 may transmit the acquired DRX configuration information in which at least the drx-onDuration parameter is set in accordance with the SST value.

The processor 534 may control DRX traffic scheduling for the UE in accordance with the default DRX configuration information, and after transmitting the acquired DRX configuration information to the UE 510, may schedule DRX traffic for the UE in synchronization with the acquired DRX configuration information.

When there is DL traffic to be transmitted to the UE during a DRX sleep period of the UE 510, the processor 534 may delay the DL traffic until the earliest time point at which the UE wakes up in accordance with the acquired DRX configuration information, and then transmit the DL traffic.

The additionally determined AMF may be determined by the default AMF on the basis of subscriber information of the UE using the NSSF and NRF. When the DRX configuration information corresponding to the allowed NSSAI value is acquired through the checked target AMF or the determined target AMF, the processor 534 may reset DRX configuration synchronized with the UE in accordance with the acquired DRX configuration information.

According to the embodiment, the processor 534 may transmit an RRC reconfiguration message including the acquired DRX configuration information to the UE 510 through the first communication module 531. For example, the processor 534 may receive an initial UE context setup message including the allowed NSSAI value and the DRX configuration information corresponding to the allowed NSSAI value from the checked target AMF or the determined target AMF.

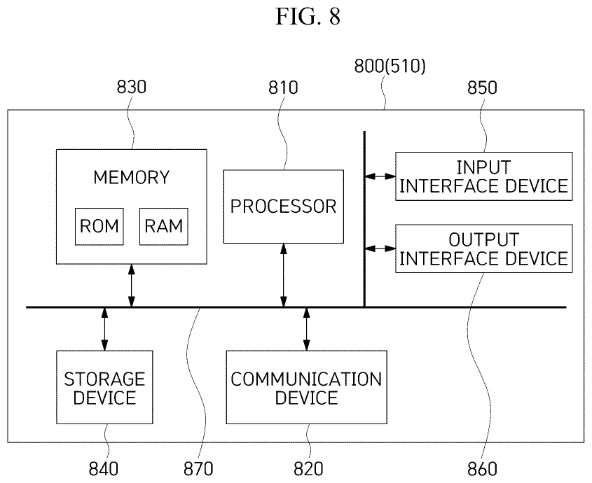

FIG. 8 is a block diagram of UE according to an embodiment.

Referring to FIG. 8, UE 800 may include at least one of a processor 810, a memory 830, an input interface device 842, an output interface device 860, and a storage device 841 that communicate via a bus 870. Also, the UE 800 may further include a communication device 820 coupled to a network. The processor 810 may be a CPU or a semiconductor device that executes instructions stored in the memory 830 or the storage device 841. The memory 830 or the storage device 841 may include various kinds of volatile or non-volatile storage media. For example, the memory 830 may include a ROM and a RAM. According to the embodiment, the memory 830 may be located inside or outside the processor 810, and the memory 830 may be connected to the processor 810 using various known means. The memory 830 may be various kinds of volatile or non-volatile storage media. For example, the memory 830 may include a ROM or a RAM.

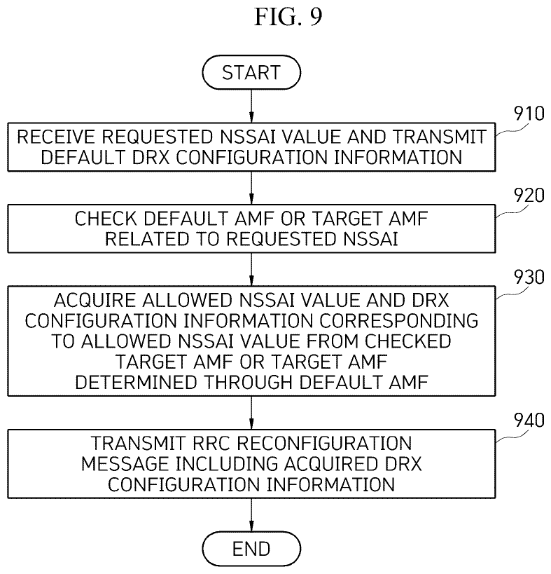

FIG. 9 is a flowchart of a DRX configuration method of a base station according to an embodiment.

Referring to FIG. 9, in operation 910, the base station 530 may receive requested NSSAI from the UE 510 during an RRC setup procedure and transmit default DRX configuration information to the UE 510.

In operation 920, the base station 530 may check a default AMF or a target AMF related to the requested NSSAI in accordance with a temporary identifier of the UE 510.

In operation 930, the base station 530 may acquire an allowed NSSAI value and DRX configuration information corresponding to the allowed NSSAI value through the checked target AMF or a target AMF additionally determined through the default AMF.

In operation 940, the base station 530 may transmit an RRC reconfiguration message including the acquired DRX configuration information to the UE.

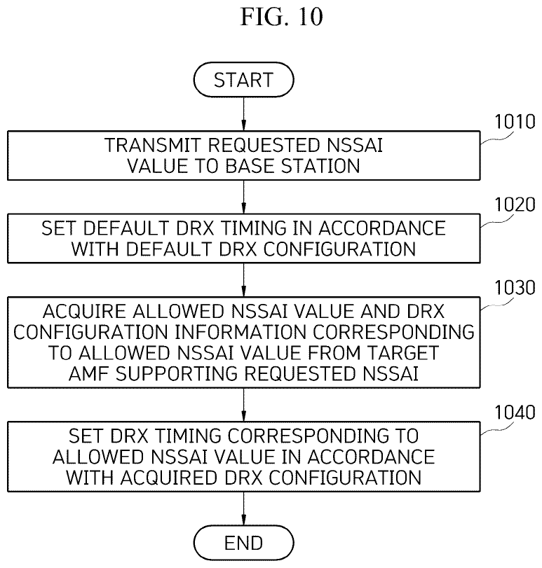

FIG. 10 is a flowchart of a DRX configuration method of UE according to an embodiment.

Referring to FIG. 10, in operation 1010, the UE 510 may transmit a requested NNSAI to the base station during an RRC setup procedure.

In operation 1020, when default DRX configuration information is received from the base station 530, the UE 510 may set a default DRX timing corresponding to the default DRX configuration information.

In operation 1030, the UE 510 may acquire an allowed NSSAI value and DRX configuration information corresponding to the allowed NSSAI value from a target AMF supporting the requested NSSAI through the base station 530.

In operation 1040, the UE 510 may reset a DRX timing corresponding to the allowed NSSAI value on the basis of the acquired DRX configuration information. For example, the UE 510 may change at least one value among a DRX inactivity timer 241, an RRC inactivity timer 242, an active (on-duration) period of a DRX cycle 232 or 233, and an on-duration period of a paging DRX cycle 231 in accordance with the DRX configuration information corresponding to the allowed NSSAI value.

It is to be understood that various embodiments of the present document and terms used in the embodiments are not intended to limit technological features set forth herein to specific embodiments and include various modifications, equivalents, or substitutions for a corresponding embodiment. With regard to the description of the drawings, similar reference numerals may be used to refer to similar or related components. A singular form of a noun corresponding to an item may include one or more of the items unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of or all possible combinations of items enumerated together in a corresponding one of the phrases. Terms such as “1^{st}” and “2^{nd}” or “first” and “second” may be used to simply distinguish a corresponding component from another, and do not limit the components in other aspects (e.g., importance or order). When a (e.g., first) component is referred to, with or without the term “functionally” or “communicatively,” as “coupled” or “connected” to another (e.g., second) component, it means that the first component may be coupled to the second component directly (e.g., by wire), wirelessly, or via a third component.

As used herein, the term “module” may include a unit implemented in hardware, software, or firmware, and may be interchangeably used with other terms, for example, “logic,” “logic block,” “part,” or “circuitry.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions stored in a storage medium (e.g., the memory 533 of FIG. 5 or the memory 830 of FIG. 8) that is readable by a machine (e.g., a base station). For example, a processor (e.g., the processor 534) of the machine (e.g., the base station 530) may invoke at least one of the one or more instructions stored in the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not distinguish between a case where data is semi-permanently stored in the storage medium and a case where data is temporarily stored in the storage medium.

According to an exemplary embodiment, a method according to various embodiments disclosed in the present document may be included and provided in a computer program product. The computer program product may be traded as a product between a seller and a buyer. The computer program product may be distributed in the form of a machine-readable storage medium (e.g., a compact disc (CD)-ROM) or distributed (e.g., downloaded or uploaded) online via an application store (e.g., Play Store™) or directly between two user devices (e.g., smartphones). When the computer program product is distributed online, at least a part of the computer program product may be temporarily generated or at least temporarily stored in the machine-readable storage medium, such as memory of the manufacturer's server, a server of the application store, or a relay server.

Components according to various embodiments of the present document may be implemented in the form of hardware such as a digital signal processor (DSP), an FPGA, or an ASIC and perform certain roles. Components are not limited to software or hardware, and each component may be configured to reside in an addressable storage medium or run on one or more processors. As an example, components may include components such as software components, object-oriented software components, class components, and task components, processes, functions, attributes, procedures, subroutines, segments of program code, drivers, firmware, microcode, circuitry, data, databases, data structures, tables, arrays, and variables.

According to various embodiments, each of the above-described components (e.g., modules or programs) may include a single entity or a plurality of entities. According to various embodiments, one or more of the above-described components or operations may be omitted, or one or more other components or operations may be added. Alternatively or additionally, a plurality of components (e.g., modules or programs) may be integrated into a single component. In this case, the integrated component may still perform one or more functions of the plurality of components in the same or similar manner as they are performed by the corresponding components among the plurality of components before the integration. According to various embodiments, operations performed by a module, a program, or another component may be carried out sequentially, in parallel, repeatedly, or heuristically, at least one of the operations may be executed in a different order or omitted, or one or more other operations may be added.

According to various embodiments disclosed in the present document, it is possible to set DRX in accordance with a network slice used by UE. In addition, various effects that are directly or indirectly found in the present document can be provided.

What is claimed is:

1. A base station comprising:
a first communication module configured to provide a 5^{th} Generation (5G) communication channel to user equipment (UE) in a specified area;
a second communication module configured to communicate with an access and mobility management function (AMF); and
a processor functionally connected to the first and second communication modules,
wherein, when a network slice is selected by the UE connected through the first communication module, the processor acquires discontinuous reception (DRX) configuration information corresponding to the selected network slice from the AMF through the second communication module and transmits a DRX timing in accordance with the DRX configuration information to the UE through the first communication module.

2. The base station of claim 1, wherein the processor transmits default DRX configuration information to the UE during a radio resource control (RCC) setup procedure of the UE and schedules DRX traffic of the UE in accordance with the default DRX configuration information.

3. The base station of claim 2, wherein, when requested network slice selection assistance information (NSSAI) is received from the UE, the processor checks a prestored default AMF or a target AMF related to the requested NSSAI in accordance with a temporary identifier of the UE, communicates with the default AMF through the second communication module to additionally determine a target AMF when no target AMF is checked, and acquires an allowed NSSAI value corresponding to the requested NSSAI and the DRX configuration information corresponding to the requested NSSAI from the checked or additionally determined target AMF through the second communication module.

4. The base station of claim 3, wherein the additionally determined AMF is determined by the default AMF on the basis of subscriber information of the UE using a network slice selection function (NSSF) and a network repository function (NRF), and
when the DRX configuration information corresponding to the allowed NSSAI value is acquired through the checked target AMF or the determined target AMF, the processor resets DRX configuration synchronized with the UE in accordance with the acquired DRX configuration information.

5. The base station of claim 3, wherein the processor receives an initial UE context setup message including the allowed NSSAI value and the DRX configuration information corresponding to the allowed NSSAI value from the checked target AMF or the determined target AMF.

6. The base station of claim 1, wherein the DRX configuration information includes parameters such as drx-onDuration, drx-InactivityTimer, drx-ShortCycle, drx-ShortCycleTimer, drx-HARQ-RTT-TimerDL, drx-HARQ-RTT-TimerUL, drx-RetransmissionTimerDL, drx-RetransmissionTimerUL, and drx_SlotOffset.

7. The base station of claim 3, wherein a network slice in accordance with the allowed NSSAI value includes a slice/service type (SST) value for identifying enhanced mobile broadband (eMBB), ultra reliability low latency communication (URLLC), massive MTC (mMTC), vehicle to everything (V2X), or high-performance machine-type communication (HMTC), and
the processor transmits the acquired DRX configuration information in which at least drx-onDuration parameter is set in accordance with the SST value.

8. The base station of claim 2, wherein the processor controls DRX traffic scheduling for the UE in accordance with the default DRX configuration information, and after transmitting the acquired DRX configuration information to the UE, performs DRX traffic scheduling for the UE in synchronization with the acquired DRX configuration information.

9. The base station of claim 1, wherein, when there is downlink (DL) traffic to be transmitted to the UE during a DRX sleep period of the UE, the processor delays the DL traffic until an earliest time point at which the UE wakes up in accordance with the acquired DRX configuration information, and then transmits the DL traffic.

10. The base station of claim 1, wherein the processor transmits a radio resource control (RCC) reconfiguration message including the acquired DRX configuration information to the UE through the first communication module.

11. A discontinuous reception (DRX) configuration method of a base station, comprising:
receiving requested network slice selection assistance information (NSSAI) from user equipment (UE) and transmitting default DRX configuration information to the UE during a radio resource control (RRC) setting procedure of the UE;
checking a default access and mobility management function (AMF) or a target AMF related to the requested NSSAI in accordance with a temporary identifier of the UE;
acquiring an allowed NSSAI value and DRX configuration information corresponding to the allowed NSSAI value through the checked target AMF or a target AMF additionally determined through the default AMF; and
transmitting an RRC reconfiguration message including the acquired DRX configuration information to the UE.

12. The DRX configuration method of claim 11, wherein the default DRX configuration information includes parameters such as drx-onDuration, drx-InactivityTimer, drx-ShortCycle, drx-ShortCycleTimer, drx-HARQ-RTT-TimerDL, drx-HARQ-RTT-TimerUL, drx-RetransmissionTimerDL, drx-RetransmissionTimerUL, and drx_SlotOffset.

13. The DRX configuration method of claim 12, wherein a network slice in accordance with the allowed NSSAI value includes a slice/service type (SST) value for identifying enhanced mobile broadband (eMBB), ultra reliability low latency communication (URLLC), massive MTC (mMTC), vehicle to everything (V2X), or high-performance machine-type communication (HMTC), and
the acquired DRX configuration information is set such that at least the drx-onDuration parameter corresponds to the SST value.

14. The DRX configuration method of claim 11, wherein the transmitting of the default DRX configuration information comprises controlling DRX traffic scheduling for the UE in accordance with the default DRX configuration information.

15. The DRX configuration method of claim 14, further comprising, after the transmitting of the acquired DRX configuration information to the UE, synchronizing the DRX traffic scheduling for the UE with the acquired DRX configuration information.

16. The DRX configuration method of claim 15, wherein the synchronizing of the DRX traffic scheduling with the acquired DRX configuration information comprises, when there is downlink (DL) traffic to be transmitted to the UE during a DRX sleep period of the UE, delaying the DL traffic until an earliest time point at which the UE wakes up in accordance with the acquired DRX configuration information, and then transmitting the DL traffic.

17. The DRX configuration method of claim 11, wherein the acquiring of the DRX configuration information comprises:
when the UE accesses the default AMF, additionally determining, by the default AMF, the target AMF on the basis of subscriber information of the UE using a network slice selection function (NSSF) and a network repository function (NRF) and transmitting the allowed NSSAI value to the UE through the determined target AMF; and
when DRX configuration information corresponding to the allowed NSSAI value is acquired through the checked target AMF or the determined target AMF, resetting DRX configuration synchronized with the UE in accordance with the acquired DRX configuration information.

18. The DRX configuration method of claim 11, wherein the acquiring of the DRX configuration information comprises receiving an initial UE context setup message including the allowed NSSAI value and the DRX configuration information corresponding to the allowed NSSAI value from the checked target AMF or the determined target AMF.

19. A discontinuous reception (DRX) configuration method of user equipment (UE), comprising:
transmitting requested network slice selection assistance information (NSSAI) to a base station during a radio resource control (RRC) setting procedure;
when default DRX configuration information is received from the base station, setting a default DRX timing corresponding to the default DRX configuration information;
acquiring an allowed NSSAI value and DRX configuration information corresponding to the allowed NSSAI value from a target access and mobility management function (AMF) supporting the requested NSSAI through the base station; and
resetting a DRX configuration to a DRX timing corresponding to the allowed NSSAI value on the basis of the acquired DRX configuration information.

20. The DRX configuration method of claim 19, wherein the resetting of the DRX configuration comprises changing at least one value among a DRX inactivity timer, an RRC inactivity timer, an active (on-duration) period of a DRX cycle, and an on-duration period of a paging DRX cycle in accordance with the DRX configuration information corresponding to the allowed NSSAI value.
